(19) United States
(12) Patent Application Publication
(10) Pub. No.: US 2008/0193270 A1
(43) Pub. Date: Aug. 14, 2008

(54) Article Transport Facility

(75) Inventors: Mitsuru Yoshida, Higashiomi-shi (JP); Yoshitaka Inui, Omihachiman-shi (JP)

Correspondence Address: THE WEBB LAW FIRM, P.C., 700 KOPPERS BUILDING, 436 SEVENTH AVENUE, PITTSBURGH, PA, 15219, US

(73) Assignee: DAIFUKU CO., LTD., Osaka (JP)

(21) Appl. No.: 12/023,383

(22) Filed: Jan. 31, 2008

(30) Foreign Application Priority Data
Feb. 9, 2007 (JP) 2007-030615

(51) Int. Cl. B66C 3/00

(52) U.S. Cl. 414/731

(57) ABSTRACT

An article transport facility comprising an article transporting mobile body with a vertically movable gripper, an article support shiftable between an article transfer position and an article storage position, wherein the article support includes a fixed frame and a movable frame having a pair of support arm portions with a plurality of connecting frames interconnecting the pair of support arm portions. A plurality of article positioning projecting members are supported to the plurality of connecting frames and held by a position setting member in a proper relative positional relationship wherein the article positioning members are distributed in the far-near direction and a direction perpendicular thereto.

### BACKGROUND OF THE INVENTION

This invention relates to an article transport facility including an article transporting mobile body movable along a path installed to a ceiling, a vertically movable gripper provided to the mobile body and configured to grip and suspend an article, an article support installed to the ceiling for storing an article, the article support being configured to shift between an article transfer position for transferring an article to and from the gripper of the mobile body at an article transfer location corresponding to the article support, and an article storage position.

An article transport facility as noted above includes a plurality of article transfer stations arranged on a floor and along the path. The mobile body moves along the path and vertically moves the gripper to transport articles between the stations.

The article supports for article storage are provided to keep temporarily articles to be transported to the stations. The article supports are usually located in article storage positions such as at a side of the path, not to interfere with movement of the mobile body. Each article support is shifted from the article storage position to the article transfer position when an article is stored on the article support or an article stored thereon is to be transported. Then, the article is transferred from the gripper of the mobile body to the article support, or vice versa.

In a conventional article transport facility, each article support includes a plate-like frame for receiving and supporting the bottom of an article, a link mechanism rockable about a horizontal axis relative to the ceiling for suspending and supporting the plate-like frame to be movable toward and away from the mobile body standing still at the article transfer station, a hydraulic cylinder for causing the link mechanism to move the plate-like frame toward and away from the mobile body, thereby shifting the article support between the article storage position and article transfer position (see JP 10-45213, for example).

When storing an article on the article support or transporting an article stored thereon, the hydraulic cylinder is operated to rock the linkage mechanism about the horizontal axis to move the plate-like frame toward and away from the mobile body standing still at the article transfer station, thereby shifting the article support from the article storage position to the article transfer position. Thereafter the gripper of the mobile body is vertically moved to deliver the article from the gripper to the plate-like frame, or to receive the article from the plate-like frame to the gripper.

In the conventional article transport facility noted above, the member that receives and supports the bottom of an article is one plate-like frame, and thus this member has a heavy weight. The link mechanism which suspends and supports the plate-like frame must be strong enough to bear the large load. This results in a large-scale construction which can also be complicated.

In the conventional article transport facility, since the plate-like frame supports the bottom of an article as merely resting thereon, the article can slip during movement toward and away from the mobile body. When the article support is shifted to the article transfer position, such a slip will result in a deviation of the article from a proper position for transfer to and from the gripper. Then, there is a possibility that the gripper cannot receive the article from the article support properly.

### SUMMARY OF THE INVENTION

This invention has been made having regard to the state of the art noted above, and its object is to provide an article transport facility which can prevent slipping of an article on an article support while reducing the weight of the article support.

To fulfill the above object, an article transport facility comprises: an article transporting mobile body movable along a path installed to a ceiling; a vertically movable gripper provided to the mobile body and configured to grip and suspend an article; an article support installed to the ceiling for storing an article, the article support being configured to shift between an article transfer position for transferring an article to and from the gripper of the mobile body at an article transfer location corresponding to the article support, and an article storage position, wherein the article support includes a fixed frame installed to the ceiling and a movable frame, the movable frame is supported to the fixed frame for movement in a far-near direction with respect to the mobile body at the article transfer location, the movable frame having a pair of support arm portions extending in the far-near direction; a plurality of connecting frames interconnecting the pair of support arm portions and spaced from each other in the far-near direction and receiving a weight of the article; a plurality of article positioning projecting members configured to engage a bottom of the article; and a position setting member, wherein the article positioning members are supported to the plurality of connecting frames and held by the position setting member in a proper relative positional relationship wherein the article positioning members are distributed in the far-near direction and a direction perpendicular thereto.

That is, the movable frame is supported by the fixed frame to be movable in the far-near direction, and the pair of support arm portions provided to the movable frame are interconnected by a plurality of connecting frames spaced from each other in the far-near direction. The plurality of connecting frames can cooperate to support the bottom of the container placed thereon. The article supported by the plurality of connecting frames can be moved in the far-near direction by moving the movable frame in the far-near direction relative to the fixed frame. Thus, the plurality of connecting frames spaced from each other in the far-near direction serve as the device for receiving and supporting the bottom of the article, thereby realizing a weight reduction of the device for receiving and supporting the bottom of the article.

Each of the connecting frames for supporting the bottom of the article has a plurality of article positioning, projecting members. These article positioning members engage the bottom of the article, whereby the article is supported while positioned by the plurality of article positioning members. This prevents undesired movement of the article.

In order to set the article to a proper position when the article is placed and supported while positioned by the plurality of article positioning members, it is necessary to install the plurality of article positioning members in a proper relative positional relationship wherein the positioning members are distributed in the far-near direction and the direction perpendicular thereto.

However, since the plurality of connecting frames support the plurality of article positioning members, the relative positional relationship of the plurality of article positioning members must be adjusted, while taking into consideration the relative positional relationship of the plurality of connecting frames. This makes installation of the plurality of article positioning members difficult. An operation for installing the article positioning members must be carried out in a high location adjacent the ceiling. It is desired to simplify the operation for installing the article positioning members.

Thus, the plurality of connecting frames support the plurality of article positioning members as held by the position setting member in the proper relative positional relationship distributed in the far-near direction and the direction perpendicular thereto. The plurality of article positioning members can be installed in the proper relative positional relationship only by installing the position setting member which holds the plurality of article positioning members in the proper relative positional relationship.

As noted above, the invention provides an article transport facility which can prevent movement of the article on the article support, while realizing a reduction in the weight of the article support, and can simplify installation of the plurality of article positioning members also.

### BRIEF DESCRIPTION OF THE DRAWINGS

FIG. 1 is a plan view of an article transport facility;

FIG. 2 is a side view of a transport vehicle and a station,

FIG. 3 is a side view of the transport vehicle;

FIG. 4 is a front view in vertical section of the transport vehicle;

FIG. 5 is a perspective view of an article support;

FIG. 6 is an exploded perspective view of the article support;

FIG. 7 is a perspective view of the article support in an article storage position;

FIG. 8 is a perspective view of the article support in an article transfer position;

FIG. 9 is a plan view of the article support in the article storage position;

FIG. 10 is a plan view of the article support in the article transfer position;

FIG. 11 is a perspective view showing a portion of the article support;

FIG. 12 is a perspective view showing a plurality of connector frames;

FIG. 13 is a sectional view showing a connector frame, a position control member and an article positioning member fastened together; and

FIG. 14 is a view showing a modified position control member.

### DETAILED DESCRIPTION OF PREFERRED EMBODIMENTS

An article transport facility according to this invention will be described with reference to the drawings.

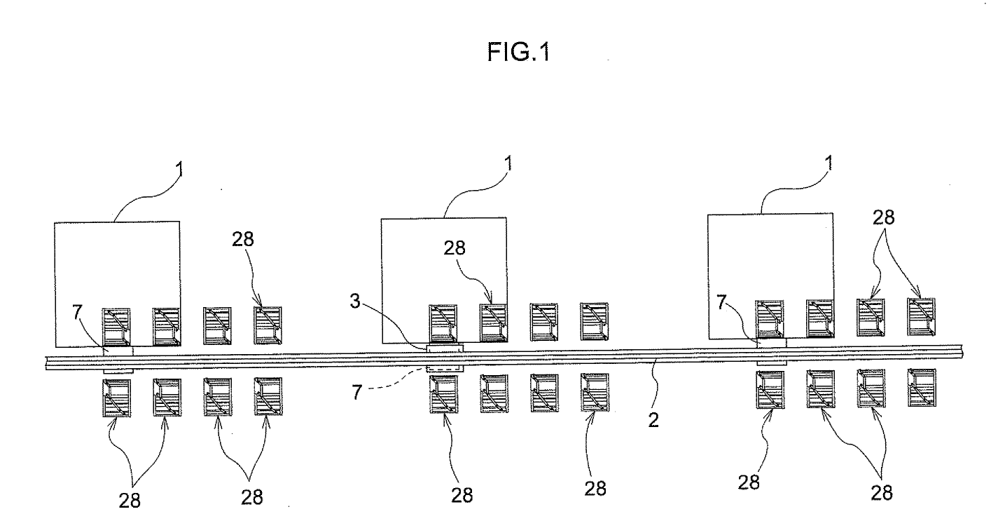

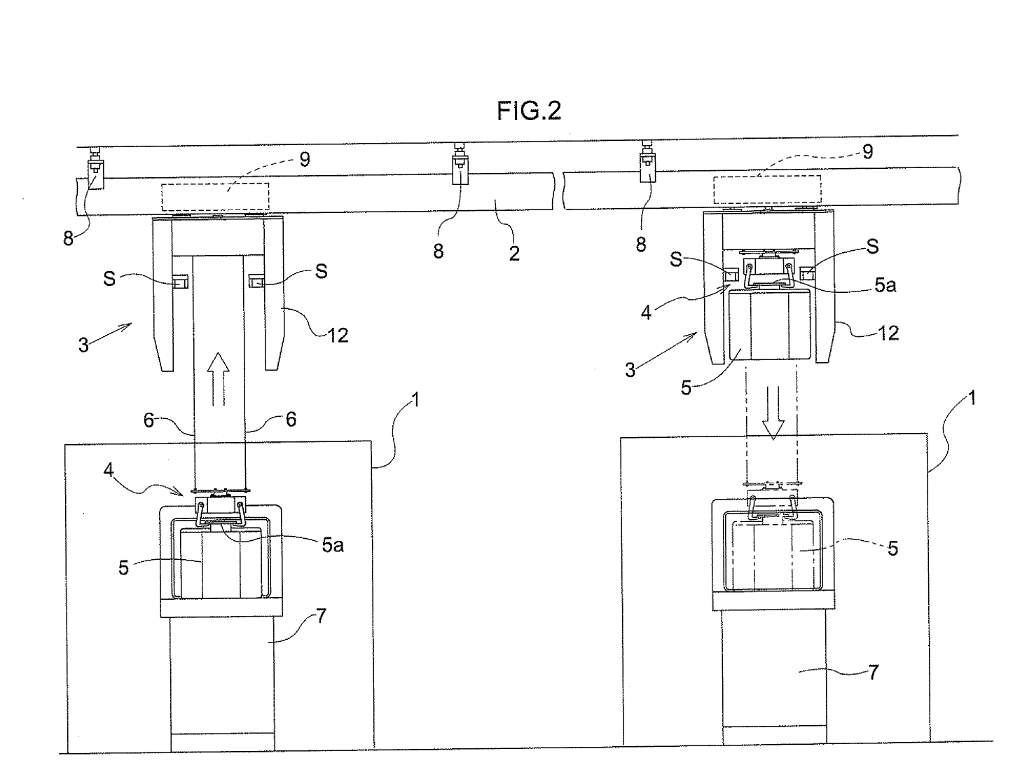

As shown in FIGS. 1 and 2, the article transport facility includes a guide rail 2 installed as a path extending along a plurality of article processing units 1, and a transport vehicle 3 acting as a mobile body movable along the guide rail 2 for transporting articles. The transport vehicle 3 transports containers 5 that function as articles for storing semiconductor substrates between the plurality of article processing units 1. Each article processing units 1 performs a predetermined process for partly finished goods in the course of manufacturing semiconductor substrates, for example.

The transport vehicle 3 has a vertically movable gripper 4 for gripping a container 5 in a suspended state.

With the transport vehicle 3 standing still, the gripper 4 is vertically movable, by winding and unwinding wires 6, between an upper position adjacent the transport vehicle 3, and a lower position for article transfer to and from an article transfer station 7 disposed below the transport vehicle 3.

FIG. 2 shows the gripper 4 being lowered from the upper position to the lower position at the upper side, and the gripper 4 being raised from the lower position to the upper position at the lower side.

The station 7 is in the form of a support table for supporting containers 5. The station 7 serves to receive containers 5 from the transport vehicle 3 for a predetermined process by the article processing unit 1, or to deliver containers 5 having undergone the predetermined process by the article processing unit 1 to the transport vehicle 3. The station 7 is provided for each of the article processing units 1.

The transport vehicle 3 moves along the guide rail 2, with the gripper 4 placed in the upper position. With the transport vehicle 3 stopped in a stopping location corresponding to a station 7 for transfer, among the plurality of stations 7, a container 5 is transferred to or from this station 7 by vertically moving the gripper 4 between the upper position and the lower position.

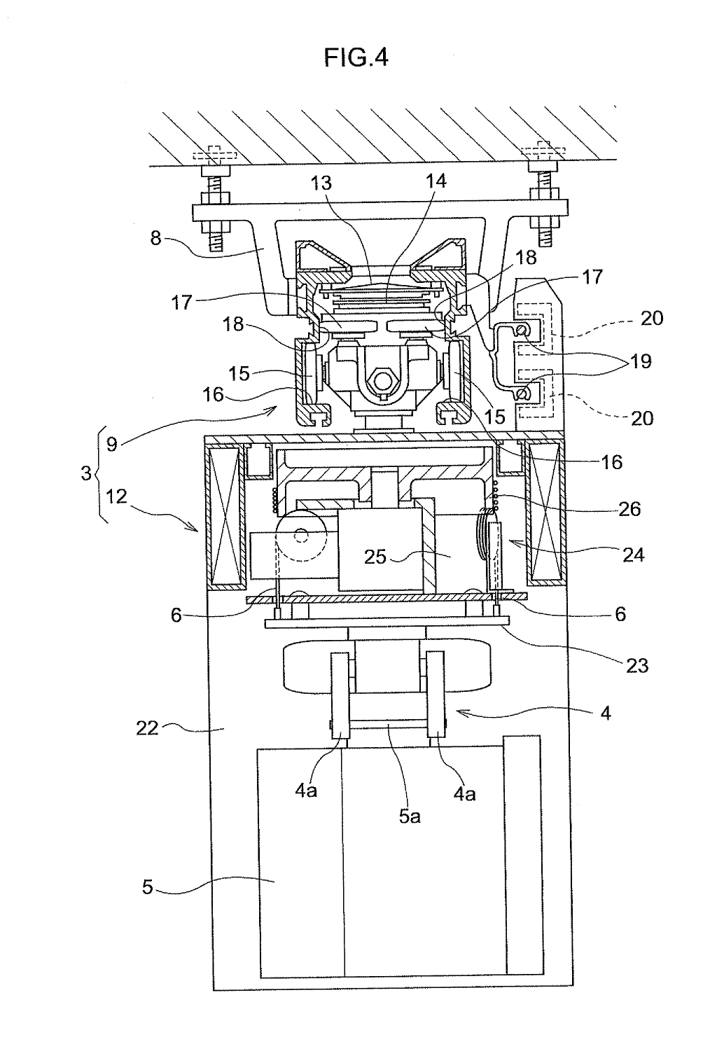

As shown in FIGS. 2 through 4, the guide rail 2 is fixed to a ceiling by guide rail brackets 8. The transport vehicle 3 includes an upper vehicle body 9 located in an inner space of the guide rail 2, and a lower vehicle body 12 located under the guide rail 2, which are connected together by fore and aft connecting rods 10 and 11.

The upper vehicle body 9 has a primary coil 14 disposed close and opposite to a magnet 13 mounted in the inner space of the guide rail 2. The upper vehicle body 9 is the linear motor type propelled by a linear motor formed of the magnet 13 and primary coil 14. The transport vehicle 3 is movable along the guide rail 2 by this propelling force.

In the inner space of the guide rail 2, running guideways 16 are formed for guiding running wheels 15 of the upper vehicle body 9, and anti-swing guideways 18 for guiding anti-swing wheels 17 of the upper vehicle body 9.

The guide rail 2 has feeder lines 19, and the upper vehicle body 9 has receiving coils 20. The feeder lines 19 supplied with AC generate magnetic fields, which cause the receiving coils 20 to generate power required by the transport vehicle 3. Thus, power is supplied in a non-contact mode.

In this embodiment, the mode for driving the upper vehicle body 9 is the linear motor type that obtains propelling force from a linear motor. Alternatively, for example, an electric motor may be provided for rotating the running wheels 15, and the upper vehicle body 9 may be driven by rotating the running wheels 15 with the electric motor.

The lower vehicle body 12 includes a fore and aft frame 21 extending in the fore and aft direction of the transport vehicle 3, and a pair of front and rear vertical frames 22 extending downward from a forward end and a rearward end of the fore and aft frames 21. The lower vehicle body 12 is channel-shaped opening downward in side view, with the gripper 4 disposed at the middle in the fore and aft direction.

The gripper 4 is attached to a lift member 23 vertically movable relative to the upper vehicle body 9. The lift member 23 is supported to be vertically movable by a lift control mechanism 24 attached to the fore and aft frame 21.

The lift control mechanism 24 has four wires 6 wound around a rotating drum 26 rotatable by a drum driving motor 25. The lift control mechanism 24 rotates the rotating drum 26 forward and backward to wind and unwind the four wires 6 simultaneously, thereby moving the lift member 23 up and down while maintaining the lift member 23 in a substantially horizontal position.

Although this embodiment shows the example of winding the wires 6 around the rotating drum 26, the lift member 23 may be vertically moved, for example, by belts wound around the rotating drum 26. Thus, the wires 6 may be replaced with belts. The wires 6 and belts are examples of flexible members.

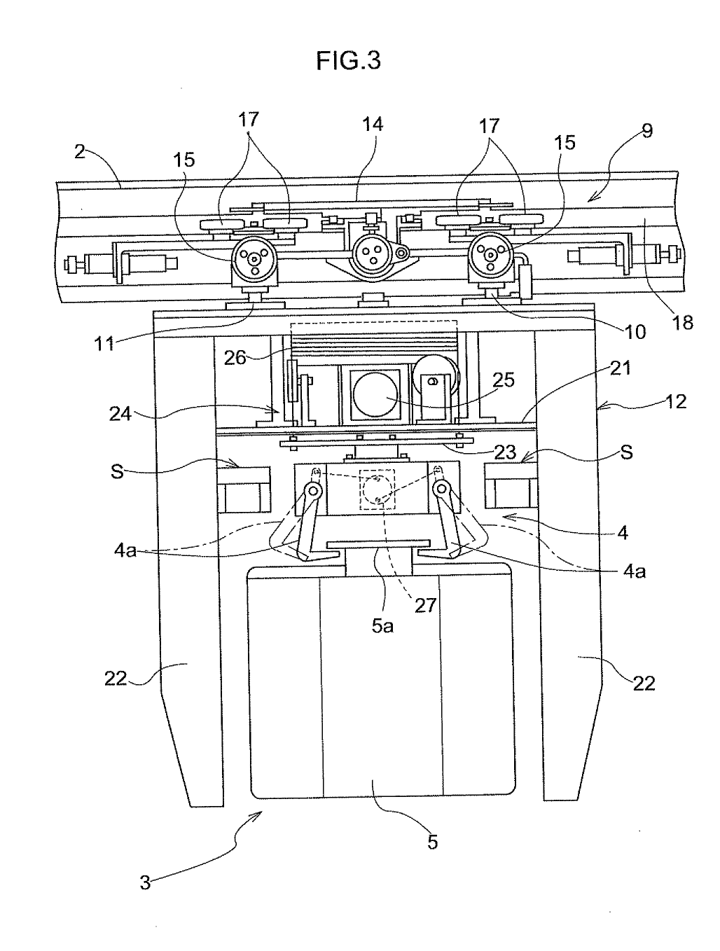

The gripper 4 includes a pair of gripping elements 4a for gripping a flange 5a of each container 5. The pair of gripping elements 4a are switchable, with forward and backward rotations of a gripping motor 27, between a gripping position for gripping the flange 5a by the gripping elements 4a rocking toward each other (solid lines in FIG. 3) and a release position for releasing the flange 5a by the gripping elements 4a rocking away from each other (dotted lines in FIG. 3).

The gripper 4 is attached to the lift member 23 to be swivelable about a vertical axis. Though not shown, a swivel motor is provided for swiveling the gripper 4.

In order to keep temporarily the containers 5 transported to the stations 7, as shown in FIG. 1, a plurality of article supports 28 for article storage are arranged at both sides of the guide rail 2. These article supports 28 are arranged along the guide rail 2.

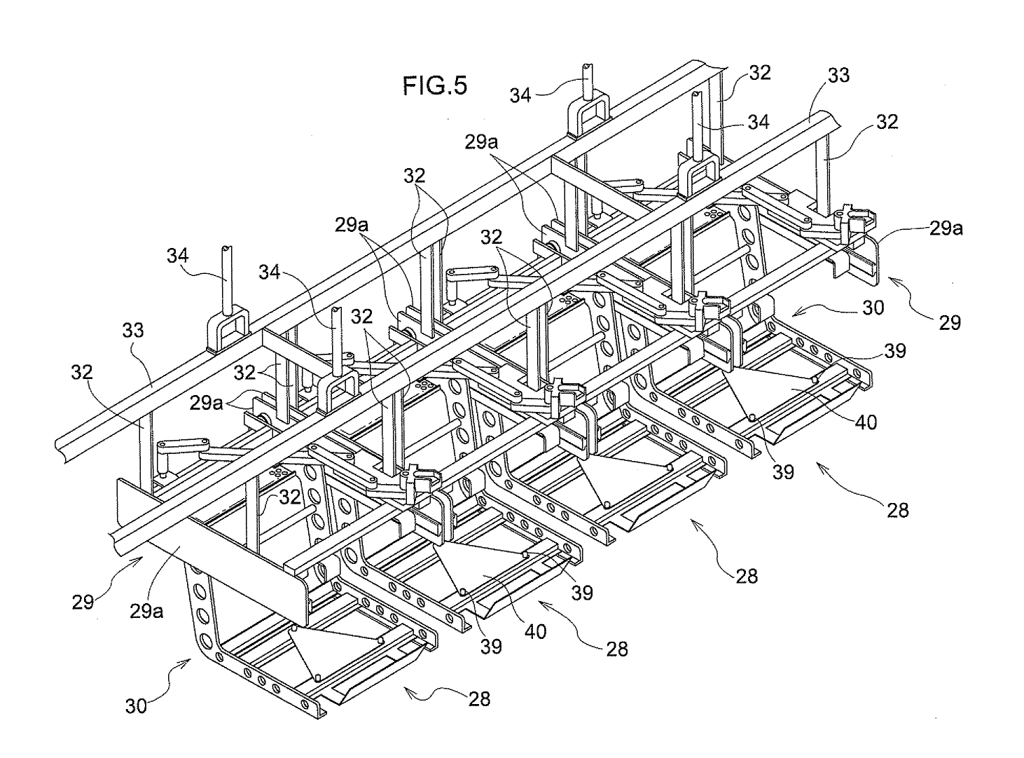

The article supports 28 will be described hereinafter with reference to FIG. 5 through 10.

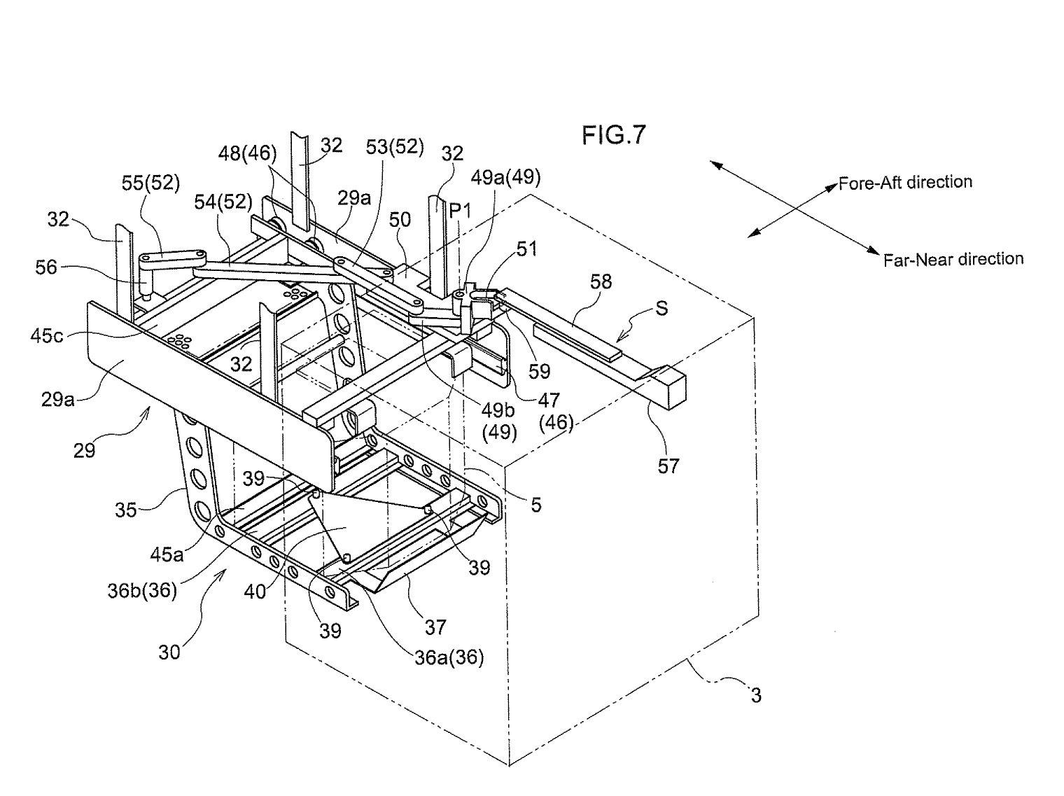

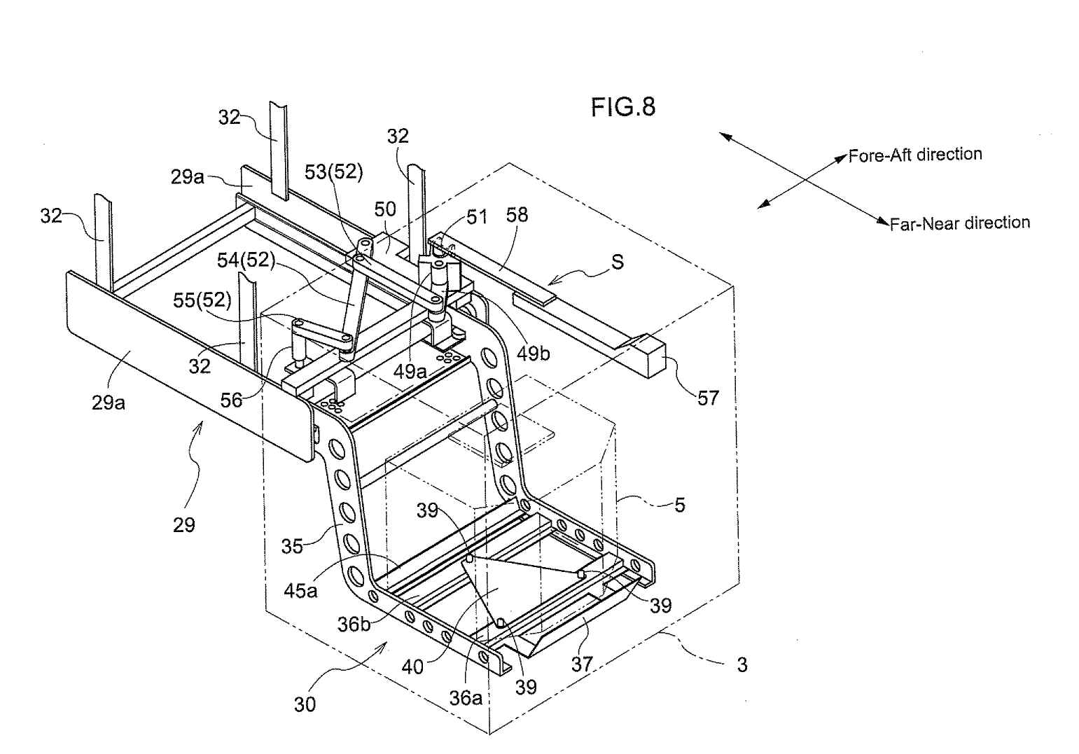

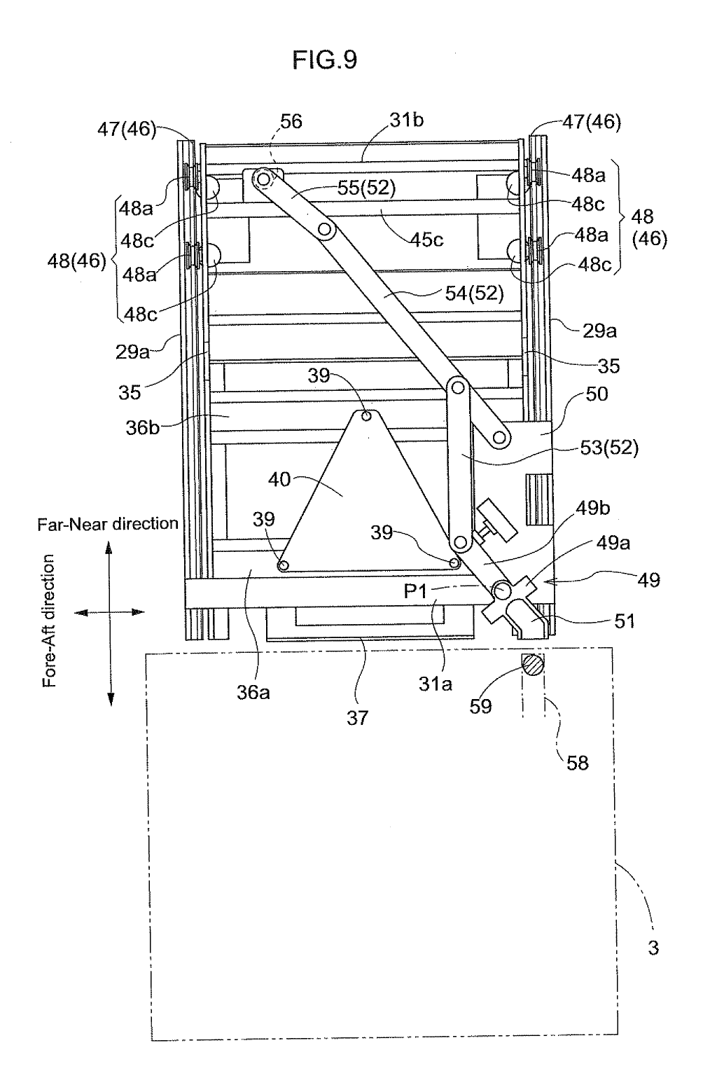

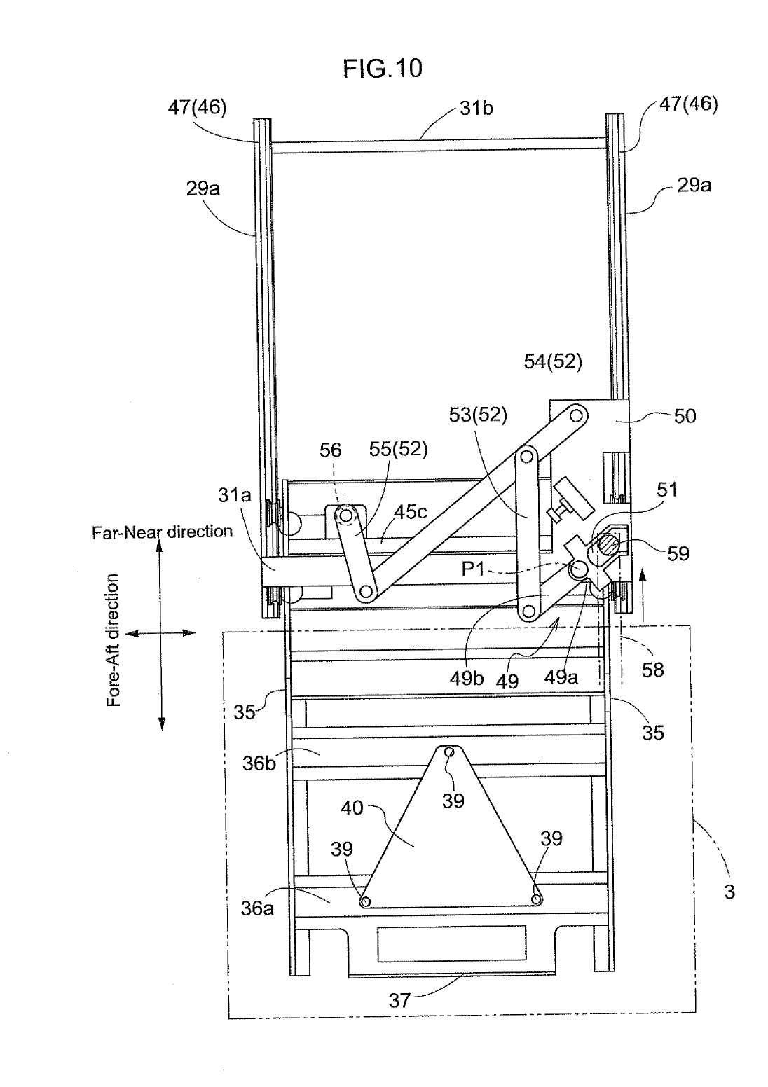

Each of the article supports 28 is shiftable between an article transfer position (see FIGS. 8 and 10) for receiving a container 5 from, and delivering a container 5 to, the gripper 4 of the transport vehicle 3 having stopped in the article transfer location corresponding thereto, and an article storage position (see FIGS. 7 and 9).

The fore and aft direction of the transport vehicle 3 standing still in the article transfer location will hereinafter be called simply “the fore and aft direction”, and the direction toward and away from the transport vehicle 3 standing still in the article transfer location simply “the far-near direction”.

The article transfer location is determined as corresponding to each of the article supports 28. In the fore and aft direction, the article support 28 is formed to have a width smaller than a distance between the pair of front and rear vertical frames 22 of the transport vehicle 3. Thus, when the transport vehicle 3 stops in the article transfer location, the article support 28 is movable into and out of the space between the pair of front and rear vertical frames 22 of the transport vehicle 3.

The article storage position is set to a side of the guide rail 2, but away from the guide rail 2 in the far-near direction, such that the article support 28, when in the article storage position, will not itself, or the container 5 placed thereon will not, obstruct movement of the transport vehicle 3 or vertical movement of the gripper 4.

The article transfer position is set to a position vertically overlapping the gripper 4 of the transport vehicle 3 standing still in the article transfer location. Thus, when the article support 28 is in the article transfer position, a container 5 can be transferred between the article support 28 and the gripper 4 located in the position adjacent the upper position of the transport vehicle 3 standing still in the article transfer location.

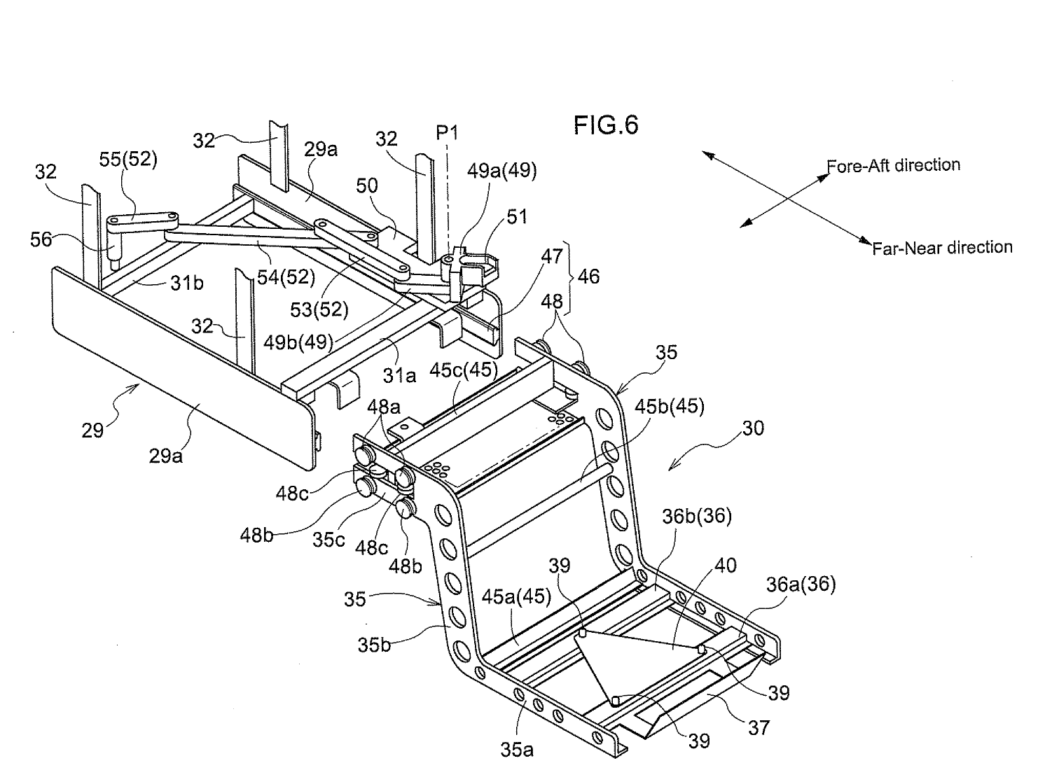

As shown in FIGS. 5 and 6, each article support 28 includes a fixed frame 29 installed on the ceiling side as corresponding to the article storage position, and a movable frame 30 supported to be movable in the far-near direction relative to the fixed frame 29.

The fixed frame 29 is formed of a pair of side frame members 29a elongated in the far-near direction. The pair of side frame members 29a are interconnected by a first frame connector 31a and a second frame connector 31b spaced from each other in the far-near direction. The first frame connector 31a interconnects the sides close, in the far-near direction, to the transport vehicle 3 standing still in the article transfer location. The second frame connector 31b interconnects the sides remote, in the far-near direction, from the transport vehicle 3 standing still in the article transfer location.

The fixed frame 29 is suspended, with a plurality of suspending extensions 32 extending upward from the pair of side frame members 29a and having upper ends fixed by mounting brackets to two suspending supports 33. The suspending supports 33 are suspended from the ceiling through suspension bolts 34 to extend longitudinally of and parallel to the guide rail 2.

The construction for supporting the fixed frame 29 as suspended from the ceiling is not limited to the above construction, but may be modified as appropriate. The fixed frame 29 may be supported as suspended from the ceiling, for example, by forming bolt-receiving grooves in the upper end of the fixed frame 29, bolting the lower ends of the suspending supports to the bolt-receiving grooves, and bolting the upper ends of the suspending supports to the ceiling.

Thus, each of the fixed frames 39 of the plurality of article supports 28 are individually supported as suspended from the ceiling, which allows each article support 28 to be attached or detached. The article supports 28 may be added or deducted with ease.

The movable frame 30 includes support arms 35 acting as a pair of right and left support arm portions formed in a shape to extend in the far-near direction, and a plurality of connecting frames 36 spaced from each other in the far-near direction and interconnecting the pair of right and left support arms 35. The support arms 35 that function as a pair of right and left support arm portions are spaced apart from each other in the fore and aft direction of the movable vehicle 3.

The movable frame 30 is constructed to support the bottom of a container 5 as placed on the plurality of connecting frames 36. The plurality of connecting frame 36 share the supporting of the bottom of the container 5 placed thereon.

The support arms 35 include lower portions 35a extending in the far-near direction, intermediate portions 35b extending upward from ends of the lower portions 35a remote, in the far-near direction, from the transport vehicle 3, and upper portions extending from upper ends of the intermediate portions 35b away, in the far-near direction, from the transport vehicle 3.

The support arms 35 have a plurality of bores formed in and arranged at intervals longitudinally of the lower portions 35a and intermediate portions 35b, which contribute to the weight reduction of the support arms 35.

The connecting frames 36 have an embossed sectional shape with a central part protruding upward, and a flat portion of the boss receives and supports the bottom of a container 5. The connecting frames 36 have opposite ends thereof placed on inwardly bent portions of the support arms 35, and fixed to the support arms 35 by bolts and nuts.

The connecting frames 36 include an elongate first connecting frame 36a located close to the transport vehicle 3 standing still in the article transfer location, and an elongate second connecting frame 36b located remote from the transport vehicle 3 standing still in the article transfer location. The first connecting frame 36a has an upstanding wall portion 37 extending toward the transport vehicle 3 standing still in the article transfer location, and upward. The upstanding wall portion 37 serves to restrict movement of a container 5 toward the transport vehicle 3 standing still in the article transfer location.

The pair of right and left support arms 35 are interconnected not only by the connecting frames 36 but also by a plurality of coupling frames 45. The coupling frames 45 include a first coupling frame 45a interconnecting the ends of the lower portions 35a of the right and left support arms 35 remote from the transport vehicle 3 standing still in the article transfer location, a second coupling frame 45b interconnecting the intermediate portions 35b of the right and left support arms 35, and a third coupling frame 45c interconnecting the upper portions 35c of the right and left support arms 35.

A slide guide mechanism 46 is provided for supporting the article support 28 to be shiftable between the article storage position (see FIGS. 7 and 9) and article transfer position (FIGS. 8 and 10). The slide guide mechanism 46 supports the movable frame 30 to be slidable in the far-near direction relative to the fixed frame 29.

The slide guide mechanism 46 includes rails 47 formed on the fixed frame 29, and a plurality of guide rollers 48 arranged on the support arms 35. With the rails 47 supporting and guiding the guide rollers 48, the slide guide mechanism 36 supports the movable frame 30 to be slidable relative to the fixed frame 29 between the article storage position and article transfer position.

The rails 47 are formed on the pair of side frame members 29a. The guide rollers 48 are arranged on the upper portions 35c of the support arms 35. The guide rollers 48 include three types of rollers, i.e. first guide rollers 48a guided by upper surfaces of the rails 47, second guide rollers 48b guided by lower surfaces of the rails 47, and third guide rollers 48c guided by side surfaces of the rails 47. Two first guide rollers 48a are spaced from each other in the far-near direction, and two second guide rollers 48b also are spaced from each other in the far-near direction, the first guide rollers 48a and second guide rollers 48b being vertically opposed to each other across each rail 47, and two third rollers 48c also spaced from each other in the far-near direction.

The fixed frame 29 includes an operated element 49 supported to be movable in the far-near direction between a proximate position (FIGS. 7 and 9) adjacent the transport vehicle 3 standing still in the article transfer location and a remote position (FIGS. 8 and 10) away from the transport vehicle 3. The operated element 49 is linked with the article support 28 such that the operated element 49, when in the proximate position, operates the article support 28 to the article transfer position, and when in the remote position, operates the article support 28 to the article storage position.

The operated element 49 has a longitudinally intermediate part thereof pivotally connected to a plate-like base 50 provided on an upper part of one of the side frame members 29a, to be rockable about a first pivot axis P1 extending through the position of connection. The operated element 49 includes a first operated portion 49a extending from the first pivot axis P1 toward the transport vehicle 3, when in the proximate position, and a second operated portion 49b extending from the first pivot axis P1 away from the transport vehicle 3, which portions 49a and 49b are formed integral together, with a level difference therebetween.

By rocking about the first pivot axis P1, the operated element 49 switches between the proximate position and remote position. In the proximate position (FIGS. 7 and 9), the first operated portion 49a acting as a forward portion assumes a position closer than the first pivot axis P1 to the transport vehicle 3 standing still in the article transfer location. The first operated portion 49a of operated element 49 has a groove 51 formed therein to extend in a direction crossing the far-near direction toward the first pivot axis P1 when the operated element 49 is located in the proximate position. The groove 51 is shaped to have an open forward end opposed to the transport vehicle 3 standing still in the article transfer location.

A linkage mechanism 52 is provided for linking movement of the operated element 49 and that of the article support 28. Thus, when the operated element 49 is located in the proximate position, as shown in FIGS. 7 and 9, the article support 28 is located in the article storage position. When the operated element 49 is located in the remote position, as shown in FIGS. 8 and 10, the article support 28 is located in the article transfer position.

The linkage mechanism 52 includes three link arms, i.e. a first link arm 53, a second link arm 54 and a third link arm 55. The first link arm 53 has one end thereof pivotally connected to one end of the second operated portion 49b of the operated element 49, and the other end pivotally connected to a longitudinally intermediate position of the second link arm 54. The second link arm 54 has one end thereof pivotally connected to the base 50, and the other end pivotally connected to one end of the third link arm 55. The third link arm 55 has the other end pivotally connected to a linking operated element 56 erected on the third coupling frame 45c.

The transport vehicle 3 includes an operating device S for shifting the article support 28 between the article storage position and article transfer position.

The operating device S has a base 57 fixed to the transport vehicle 3 and elongated in the far-near direction, an elongate control member 58 movable in the far-near direction relative to the base 57, and an engaging roller 59 attached to a lower surface at a forward end of the control member 58. The operating device S has an actuator, not shown, operable to project and retract the control member 58 relative to the base 57, thereby carrying out a projecting operation and a retracting operation to move the engaging roller 59 in the far-near direction.

The transport vehicle 3 includes such operating device S for acting on the article supports 28 arranged on the right-hand side in the direction of movement of the transport vehicle 3, and a further operating device S for acting on the article supports 28 arranged on the left-hand side.

The engaging roller 59 has a diameter corresponding to or smaller than the width of the groove 51 of the operated element 49 in the fore and aft direction. Thus, the engaging roller 59 is engageable with and disengageable from the groove 51 of the operated element 49 through movement in the far-near direction.

The operating device S is constructed the push-pull type such that, in the projecting operation, the engaging roller 59 is moved into engagement with the groove 51 to push the operated element 49 from the proximate position to the remote position, and in the retracting operation, the engaging roller 59 is retained in engagement with the groove 51 to pull the operated element 49 from the remote position to the proximate position, and thereafter the engaging roller 59 is disengaged from the groove 51.

When the operating device S moves the operated element 49 from the proximate position to the remote position with the engaging roller 59 in the projecting operation, the operated element 49 located in the remote position will result in the article support 28 located in the article transfer position. Thus, the article support 28 is shifted from the article storage position to the article transfer position.

When the operating device S moves the operated element 49 from the remote position to the proximate position with the engaging roller 69 in the retracting operation, the operated element 49 located in the proximate position results in the article support 28 located to the article storage position. Thus, the article support 28 is shifted from the article transfer position to the article storage position.

Movements taking place when the article support 28 is shifted between the article storage position and article transfer position will be described.

When the operated element 49 is located in the proximate position as shown in FIGS. 7 and 9, the opening of the groove 51 opens in the far-near direction. The operating device S executes the projecting operation to move the engaging roller 59 in the far-near direction to project from the transport vehicle 3, and through the opening of the groove 50 into the groove 51 to engage the latter. As the engaging roller 59 engaging the groove 51 is further moved in the far-near direction to project from the transport vehicle 3, the engaging roller 59, while pressing a side wall of the groove 51, moves through the groove 51 to push the operated element 49 from the proximate position to the remote position. As the operated element 49 rocks from the proximate position to the remote position, the first link arm 53, second link arm 54 and third link arm 55 of the linkage mechanism 52 rock successively, to move the linking operated element 56 toward the transport vehicle 3. The movement of the linking operated element 49 toward the transport vehicle 3, with the slide guide mechanism 46 slidably supporting and guiding the article support 28, shifts the article support 28 from the article storage position to the article transfer position as shown in FIGS. 8 and 10.

When the operating device S executes the retracting operation, with the operated element 49 located in the remote position as shown in FIGS. 8 and 10, the engaging roller 59 will move toward the transport vehicle 3 while engaging the groove 51. The engaging roller 59 moves through the groove 51 while pressing a side wall of the groove 51, to pull the operated element 49 from the remote position to the proximate position. As the operated element 49 rocks from the remote position to the proximate position, the first link arm 53, second link arm 54 and third link arm 55 of the linkage mechanism 52 rock successively, to move the linking operated element 56 away from the transport vehicle 3. The movement of the linking operated element 56 away from the transport vehicle 3, with the slide guide mechanism 46 slidably supporting and guiding the article support 28, shifts the article support 28 from the article transfer position to the article storage position. When the operated element 49 is located in the proximate position as shown in FIGS. 7 and 9, the opening of the groove 51 opens in the far-near direction. Thus, the engaging roller 59 moving toward the transport vehicle 3 will become disengaged from the groove 51 and retract to the transport vehicle 3.

The construction of the article support 28 for receiving and supporting the bottom of a container 5 will be described further hereinafter.

The article support 28 has two connecting frames 36 spaced from each other in the far-near direction to share the supporting of the bottom of the container 5 placed thereon. This construction is intended to lighten the article support 28. The two connecting frames 36 are arranged to receive and support end portions in the far-near direction of the bottom of the container 5. Thus, the container 5 is supported in a balanced way.

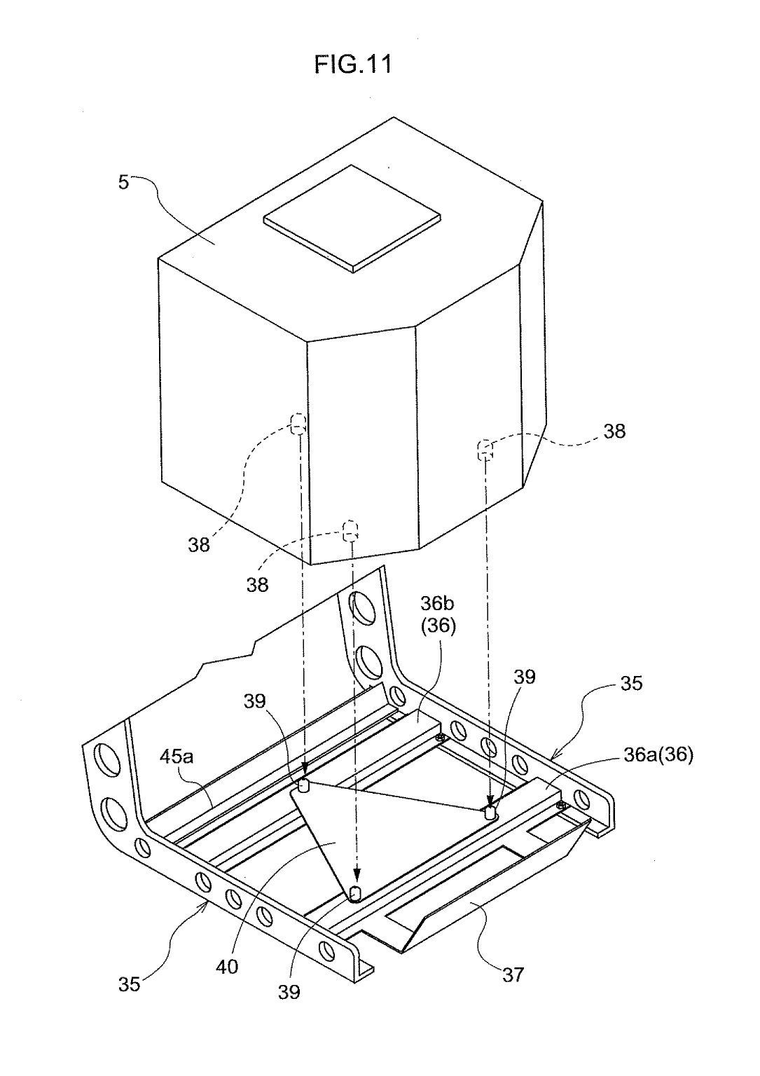

As shown in FIG. 11, the plurality of connecting frames 36 support a plurality of article positioning, projecting members 39 for engaging engageable portions 38 in the bottom of the container 5. The plurality of article positioning members 39 are held by a position setting member 40 in a proper relative positional relationship distributed in the far-near direction and the fore and aft direction perpendicular thereto.

The first connecting frame 36a supports two article positioning members 39 spaced from each other in the fore and aft direction. The second connecting frame 36b supports one article positioning member 39. The article positioning member 39 on the second connecting frame 36b is located in substantially the middle position longitudinally of the second connecting frame 36b. The two article positioning members 39 on the first connecting frame 36a are installed to have a predetermined distance in the fore and aft direction from the position of the article positioning member 39 on the second connecting frame 36b. The position setting member 40 is formed to have a triangular shape in plan view, and holds the article positioning members 39 at the respective corners thereof.

The proper relative positional relationship noted above corresponds to a relative positional relationship of the engageable portions 38 formed in the bottom of the container 5. When the plurality of article positioning members 39 engage the respective engageable portions 38, the container 5 is set to a proper position.

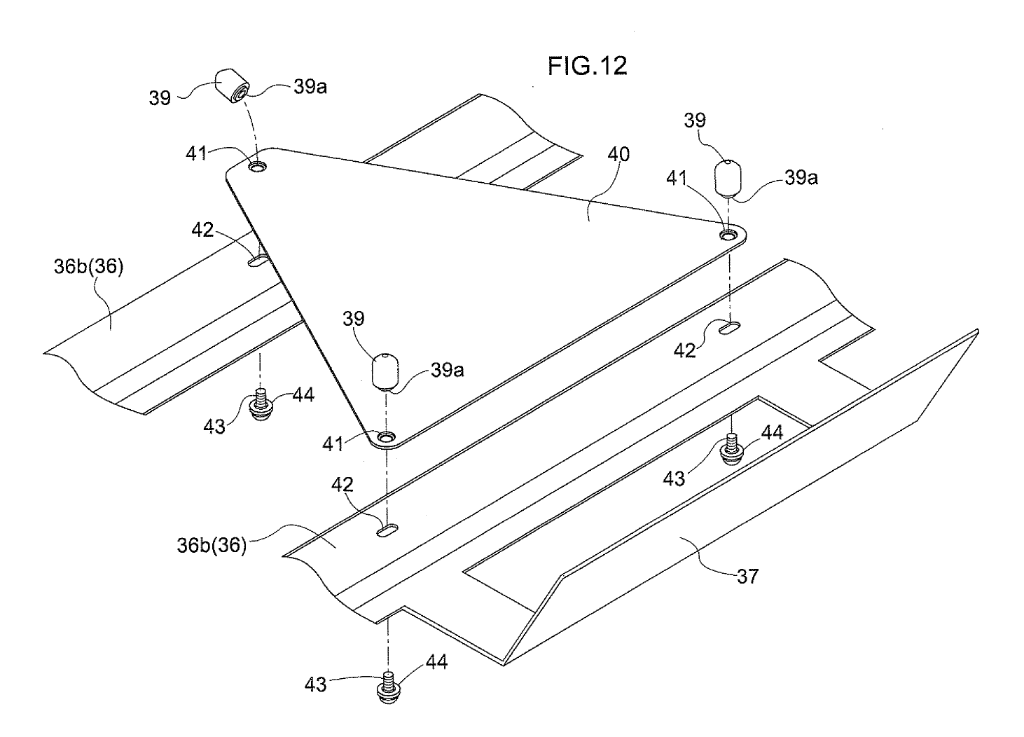

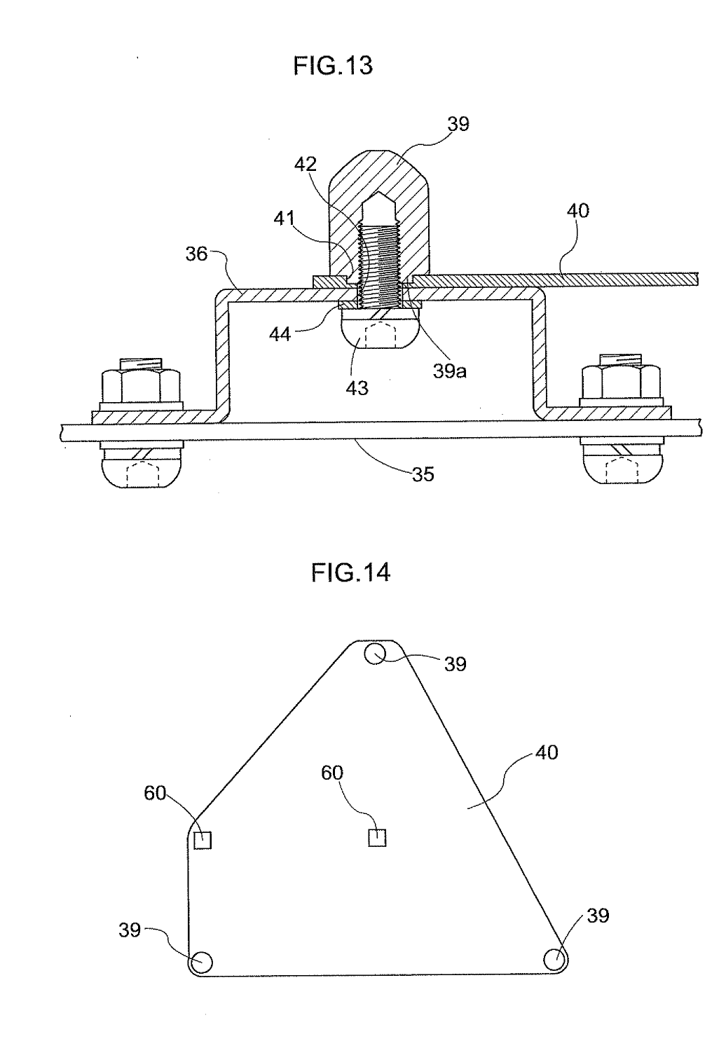

As shown in FIGS. 12 and 13, the article positioning members 39 are in the form of projecting pins. Each article positioning member 39 has a projection 39a formed on a bottom thereof, which is small in diameter for fitting in a positioning bore 41 in the position setting member 40, and has a length equal to or smaller than the thickness of the position setting member 40.

With the position setting member 40 fitted with the article positioning members 39 and placed on the connecting frames 36, fastening bolts 43 are inserted upward from below into bolt receiving bores 42 formed in the connecting frames 36, and meshed with the bottoms of the article positioning members 39. In this way, the article positioning members 39 are fastened to the connecting frames 36.

Each positioning bore 41 is formed as a stepped fitting bore with an upper portion having a large diameter and a lower portion having a small diameter. The projection 39a of each article positioning member 39 fits in the large diameter portion of the positioning bore 41.

Each bolt receiving bore 42 formed in the connecting frame 36 is larger than the diameter of the fastening bolt 43 for positional adjustment of the article positioning member 39. The bolt receiving bore 42 is elongated in the fore and aft direction, so that the article positioning member 39 positionally adjustable in the fore and aft direction.

When installing the three article positioning members 39, each of the three article positioning members 39 is first fitted in the positioning bore 41 in the position setting member 40. The position setting member 40 is placed on the connecting frames 36, with each of the three article positioning members 39 positionally adjusted to the bolt receiving bore 42 in the connecting frame 36. The fastening bolts 43 are inserted upward from below into the bolt receiving bores 42 formed in the connecting frames 36, and meshed with the bottom of the article positioning members 39 through washers 44.

In this way, the article positioning members 39 are fastened to the connecting frames 36, with the position setting member 40 pinched between the article positioning member 39 and connecting frames 36. When the three article positioning members 39 deviate from the proper relative positional relationship in the fore and aft direction at this time, the article positioning members 39 are positionally adjusted by adjusting fastening positions in the bolt receiving bores 42.

The installation positions of the first connecting frame 36a and the installation position of the second connecting frame 36b in the far-near direction are adjusted, so that the three article positioning members 39 may be in a proper relative positional relationship in the far-near direction.

The transport vehicle 3 includes a carriage controller for controlling operation of the transport vehicle 3. Based on commands from a supervising computer that controls operation of the entire article transport facility, and on detection information from various sensors provided on the transport vehicle 3, the carriage controller controls movement of the transport vehicle 3, lifting operation of the gripper 4, operation of the gripping motor 27, and operation of the operating device S.

When, for example, the supervising computer gives a transport command indicating a transport starting station 7 and a destination station 7 among the plurality of stations 7, and instructing an operation to transport a container 5 from the starting station 7 to the destination station 7, the carriage controller controls operation of the transport vehicle 3 to receive the container 5 from the starting station 7, and deliver the container 5 to the destination station 7.

When receiving the container 5 from the starting station 7, the carriage controller first controls movement of the transport vehicle 3 to stop the transport vehicle 3 in a stopping position corresponding to the starting station 7. Next, with the transport vehicle 3 standing still in the stopping position corresponding to the starting station 7, the carriage controller performs lift control of the gripper 4 to lower the gripper 4 from the upper position to the lower position. When the gripper 4 is located in the lower position, the carriage controller operates the gripping motor 27 to switch the pair of gripping elements 4a to the gripping position, whereby the gripping elements 4a grip the flange 5a of the container 5. The container 5 is received in this way. Subsequently, the carriage controller performs lift control of the gripper 4 to raise the gripper 4 from the lower position to the upper position. Then, the carriage controller controls movement of the transport vehicle 3 to stop the transport vehicle 3 in a stopping position corresponding to the destination station 7.

When the transport vehicle 3 has stopped in the stopping position corresponding to the destination station 7, the carriage controller delivers the container 5 to the destination station 7 by lift control of the gripper 4 and operation of the gripping motor 27, as performed when receiving the container 5 from the starting station 7.

The supervising computer may give a storage command indicating one of the plurality of article supports 28, and instructing an operation to store a container 5 on the indicated article support 28. Such a case will be described hereinafter.

The carriage controller first controls movement of the transport vehicle 3 to move the transport vehicle 3 to an article transfer location corresponding to the article support 28 for transfer. Next, with the transport vehicle 3 standing still in the article transfer location corresponding to the article support 28 for transfer, the carriage controller causes the operating device S to execute the projecting operation. The projecting operation of the operating device S shifts the article support 28 from the article storage position to the article transfer position. After performing lift control of the gripper 4 to lower the gripper 4 from the upper position to a position adjacent the article support 28, the carriage controller operates the gripping motor 27 to switch the pair of gripping elements 4a to the release position, thereby delivering the container 5 from the gripper 4 to the article support 28 located in the article transfer position. Then, after performing lift control of the gripper 4 to raise the gripper 4 to the upper position, the carriage controller causes the operating device S to execute the retracting operation. The retracting operation of the operating device S shifts the article support 28 from the article transfer position to the article storage position.

The supervising computer may give a fetch command indicating one of the plurality of article supports 28, and instructing an operation to fetch a container 5 from the indicated article support 28. Such a case will be described hereinafter.

The carriage controller controls movement of the transport vehicle 3, as in the case of the storage command, to stop the transport vehicle 3 in an article transfer location corresponding to the article support 28 for transfer. Then, the carriage controller causes the control devise S to execute the projecting operation. The projecting operation of the operating device S shifts the article support 29 from the article storage position to the article transfer position. After performing lift control of the gripper 4 to lower the gripper 4 from the upper position to a position adjacent the article support 28, the carriage controller operates the gripping motor 27 to switch the pair of gripping elements 4a to the gripping position, thereby receiving the container 5 from the article support 28. Then, after performing lift control of the gripper 4 to raise the gripper 4 to the upper position, the carriage controller causes the control devise S to execute the retracting operation. The retracting operation of the operating device S shifts the article support 28 from the article transfer position to the article storage position.

### OTHER EMBODIMENTS

(1) In the embodiment described hereinbefore, the position setting member 40 is formed triangular. The shape of the position setting member 40 may be varied as appropriate.

For example, as shown in FIG. 14, the position setting member 40 may have a shaped deformed from the triangle in order to form reflectors 60 on the position setting member 40. In this case, the position of a container 5 on the article support 28 is detectable by detecting the reflectors 60 on the position setting member 40 with detecting sensors attached to the gripper 4.

(2) In the embodiment described hereinbefore, to install the article positioning members 39 and position setting member 40, the position setting member 40 fitted with the article positioning members 39 is placed on the connecting frames 36, and the article positioning members 39 are fastened to the connecting frames 36 with the fastening bolts 43. The article positioning members 39 may be installed in a varied way as appropriate.

For example, the position setting member 40 may be bolted to the connecting frames 36, and the article positioning members 39 bolted to the position setting member 40 bolted to the connecting frames 36.

(3) The embodiment described hereinbefore provides two connecting frames 36. The number of connecting frames 36 may be varied as appropriate. The article positioning members 39 may also be varied as appropriate.

(4) In the embodiment described hereinbefore, the article support 28 in the article transfer position transfers a container 5 to and from the gripper 4 located in a position close to the upper position. For example, the article support 28 in the article transfer position may transfer a container 5 to and from the gripper 4 located in the upper position.

The position of the article support 28 for transferring a container 5 to and from the gripper 4 is not limited to the upper position or the position close to the upper position, but may be a position lower by a set height than the upper position. In this case, a container 5 may be transferred between the article support 28 and gripper 4 by lowering the gripper 4 by the set height from the upper position in the state of the article support 28 being located in the article transfer position.

(5) In the embodiment described hereinbefore, a plurality of article supports 28 are arranged along the guide rail 2. The number of article supports 28 may be varied as appropriate. While the article supports 28 are installed at both sides of the guide rail 2, they may be installed only at one side of the guide rail 2.

(6) In the embodiment described hereinbefore, the transport vehicle 3 has two control devices S, i.e. the operating device S for shifting the article supports 28 arranged at the right-hand side in the direction of movement of the transport vehicle 3, and the operating device S for shifting the article supports 28 arranged at the left-hand side in the direction of movement of the transport vehicle 3. For example, the transport vehicle 3 may have one operating device S with the engaging roller 59 movable to project rightward and leftward from the transport vehicle 3.

(7) In the embodiment described hereinbefore, the article transport facility transports, as articles, containers 5 storing semiconductor substrates. The articles transported may be varied as appropriate.

What is claimed is:

1. An article transport facility comprising:
an article transporting mobile body movable along a path installed to a ceiling;
a vertically movable gripper provided to the mobile body and configured to grip and suspend an article;
an article support installed to the ceiling for storing an article, the article support being configured to shift between an article transfer position for transferring an article to and from the gripper of the mobile body at an article transfer location corresponding to the article support, and an article storage position, wherein the article support includes a fixed frame installed to the ceiling and a movable frame, the movable frame is supported to the fixed frame for movement in a far-near direction with respect to the mobile body at the article transfer location, the movable frame having a pair of support arm portions extending in the far-near direction;
a plurality of connecting frames interconnecting the pair of support arm portions and spaced from each other in the far-near direction and receiving a weight of the article;
a plurality of article positioning projecting members configured to engage a bottom of the article; and
a position setting member, wherein the article positioning members are supported to the plurality of connecting frames and held by the position setting member in a proper relative positional relationship wherein the article positioning members are distributed in the far-near direction and a direction perpendicular thereto.

2. An article transport facility as defined in claim 1, wherein each of the article positioning members has a projection formed on a bottom thereof, which is small in diameter for fitting in a positioning bore formed in the position setting member, and which has a length equal to or smaller than a thickness of the position setting member; and
the article positioning members are fastened to the connecting frames by bolts while the position setting member fitted with the article positioning members is placed on the connecting frames wherein the bolts are configured to be inserted upward from below into bolt receiving bores formed in the connecting frames and to be threadedly engaged with bottoms of the article positioning members.

3. An article transport facility as defined in claim 2, wherein the bolt receiving bores formed in the connecting frames are larger than a diameter of the fastening bolts for positional adjustment of the article positioning members.

4. An article transport facility as defined in claim 1, wherein the mobile body includes operating means for shifting the article support between the article storage position and the article transfer position when the mobile body is at the article transfer location.

5. An article transport facility as defined in claim 1, wherein said path is defined by an overhead rail, said mobile body being a vehicle configured to move along said rail, said vehicle including a lift mechanism having a flexible member, and said article gripper being configured to be moved vertically between an upper position and a lower position by said lift mechanism through said flexible member.

6. An article transport facility as defined in claim 5, wherein said vehicle includes a front vertical frame and a rear vertical frame with respect to a direction of movement thereof, said upper position being one in which said article gripper is located between said front and rear frames, and said lower position being a position suited for placing an article on a ground station.

7. An article transport facility as defined in claim 6, wherein said article support is disposed substantially at a same vertical height as said article gripper in said upper position, so that said article support can receive an article from said article gripper by moving substantially horizontally to said article transfer position.
